(19) United States
(12) Patent Application Publication
(10) Pub. No.: US 2025/0102283 A1
(43) Pub. Date: Mar. 27, 2025

(54) Digital Bridge Cam Gauge

(71) Applicant: Brett Laturnus, Penticton (CA)

(72) Inventor: Brett Laturnus, Penticton (CA)

(21) Appl. No.: 18/471,370

(22) Filed: Sep. 21, 2023

(51) Int. Cl. G01B 3/22

(52) U.S. Cl. CPC G01B 3/22

(57) ABSTRACT

A gauge for measuring one or more welding parameters of a weld joint is disclosed. The gauge includes a gauge body having a front surface and a rear surface and an arcuate plate rotatably coupled to the gauge body and arranged facing the front surface of the gauge body. The arcuate plate facilitates a measurement of one or more first parameters out of the one or more welding parameters of the weld joint. The gauge further includes a sensing unit configured to determine a relative position of the arcuate plate and the gauge body and a controller arranged in communication with the sensing unit and configured to determine a value of the one or more welding parameters based upon an input received from the sensing unit.

### BACKGROUND

### 1. Technical Field

The present disclosure relates, generally, to a gauge, more particularly to a digital bridge cam gauge used for measuring different parameters of welded joints.

### 2. Description of the Prior Art

A bridge cam gauge is used for precision measurement of various welding parameters associated with welded joints. However, the traditional bridge cam gauges are difficult to read and cannot be used for quick measurement. Also, a person needs to be trained to precisely measure and read the welding parameters using the traditional bridge cam gauges.

### SUMMARY

One aspect of this disclosure relates to a gauge for measuring one or more welding parameters of a weld joint. The gauge includes a gauge body and an arcuate plate rotatably coupled to the gauge body and arranged facing a front surface of the gauge body. The arcuate plate facilitates a measurement of the one or more welding parameters of the weld joint. The gauge further includes a sensing unit configured to determine a relative position of the arcuate plate and the gauge body and a controller arranged in communication with the sensing unit and configured to determine a value of the one or more welding parameters based upon an input received from the sensing unit.

In some additional, alternative, or selectively cumulative embodiments, the gauge further includes a display device communicatively coupled with the controller and adapted to display the determined values of the one or more welding parameters.

In some additional, alternative, or selectively cumulative embodiments, the sensing unit includes a plurality of first sensors coupled to one of the gauge body and the arcuate plate and at least one second sensor coupled to other of the arcuate plate and the gauge body and configured to interact with the plurality of the first sensors to determine the relative position of the arcuate plate.

In some additional, alternative, or selectively cumulative embodiments, the gauge further includes a mode selector to enable a user to select a mode out of a plurality of modes associated with the one or more welding parameters to measure a desired first parameter out of the one or more welding parameters.

In some additional, alternative, or selectively cumulative embodiments, the gauge further includes a measurement unit selector to enable a user to select a desired measurement unit system out of a plurality of measurement unit system to display the value of the determined welding parameter in the desired measurement unit system.

In accordance with another example embodiment, a gauge for measuring one or more welding parameters of a weld joint is disclosed. The gauge includes a gauge body and an arcuate plate rotatably coupled to the gauge body and arranged facing a front surface of the gauge body. The arcuate plate facilitates a measurement of the one or more welding parameters of the weld joint. The gauge further includes a sensing unit configured to determine a relative position of the arcuate plate and the gauge body, a controller arranged in communication with the sensing unit and configured to determine a value of the one or more welding parameters based upon an input received from the sensing unit, and a display device communicatively coupled with the controller and adapted to display the determined value of the one or more welding parameters.

In some additional, alternative, or selectively cumulative embodiments, the sensing unit includes a plurality of first sensors coupled to one of the gauge body and the arcuate plate and at least one second sensor coupled to other of the arcuate plate and the gauge body and configured to interact with the plurality of the first sensors to determine the relative position of the arcuate plate.

In some additional, alternative, or selectively cumulative embodiments, the gauge further includes a mode selector to enable a user to select a mode out of a plurality of modes associated with the one or more welding parameters to measure a desired first parameter out of the one or more welding parameters.

In some additional, alternative, or selectively cumulative embodiments, the gauge further includes a measurement unit selector to enable a user to select a desired measurement unit system out of a plurality of measurement unit system to display the value of the determined welding parameter in the desired measurement unit system.

### BRIEF DESCRIPTION OF THE DRAWINGS

FIG. 1 illustrates a front view of a digital bridge cam gauge depicting a front surface of a gauge body, in accordance with an embodiment of the disclosure; and

FIG. 2 illustrates a block diagram of a measuring unit of the digital bridge cam gauge, in accordance with an embodiment of the disclosure.

### DETAILED DESCRIPTION

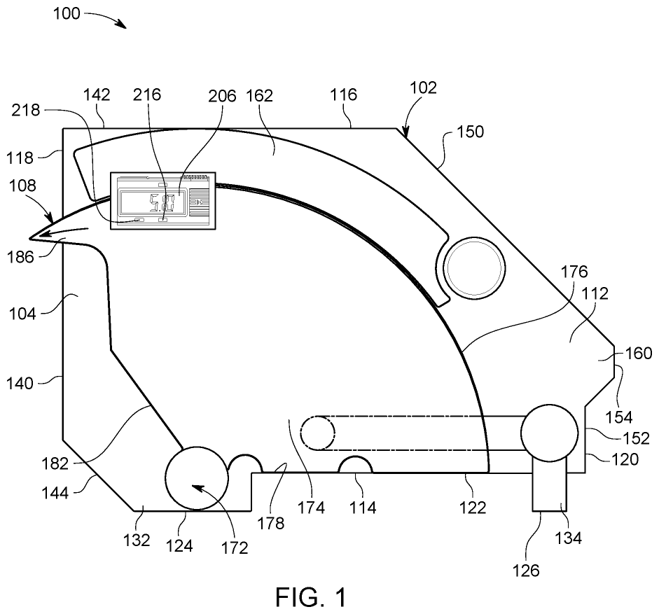

Referring to FIG. 1, a digital bridge cam gauge 100 (hereinafter referred as simply gauge 100) configured to measure one or more welding parameters related to a welded joint is shown, according to example embodiments of the disclosure. In an embodiment, the one or more welding parameters, for example, an angle of preparation, an excess weld reinforcement, a depth of welding undercut, a fillet weld leg length, and an outside misalignment, etc. In an embodiment, the one or more welding parameters include one or more first parameters, such as, the excess weld reinforcement, the depth of welding undercut, the fillet weld leg length, and the outside misalignment, and one or more second parameters, for example, the angle of preparation. As shown, the gauge 100 includes a gauge body 102 having a front surface 104 and a rear surface 106 and an arcuate plate 108 rotatably coupled to the gauge body 102.

As shown, the gauge body 102 is a plate 112 including a polygonal shape having a first side 114 (i.e., bottom side), a second side 116 (i.e., top side) arranged opposite to the bottom side 114, a third side 118 extending between the bottom side 114 and the top side 116 and connecting the bottom side 114 to the top side 116, and a fourth side 120 arranged spaced apart and opposite of the third side 118. The fourth side 120 also extends from the bottom side 114 to the top side 116, connecting the bottom side 114 to the top side 116.

As shown, the bottom side 114 includes a first bottom edge portion 122, a second bottom edge portion 124 extending from the first bottom edge portion 122 to the third side 118, and a third bottom edge portion 126 extending from the first bottom edge portion 122 to the fourth side 120. The second and third bottom edge portions 124, 126 extend substantially parallel to the first bottom edge portion 122 and are disposed at an offset from the first bottom edge portion 122 in direction perpendicular to the extension of the bottom side 114 between the third side 118 and the fourth side 120. Accordingly, the second bottom edge portion 124 and the third bottom edge portion 126, respectively, define a first foot 132 and a second foot 134, of the gauge 100. In an embodiment, the second foot 134 is movably/slidably coupled to the third side 118 to enable a variation in a distance between the first foot 132 and the second foot 134. To enable the slidable coupling of the second foot 134, the gauge body define a groove and the second foot 134 is adapted to slide along the groove and is secured to a desired position via a screw.

Further, the third side 118 includes a first side edge portion 140 extending downwardly towards the second bottom edge portion 124 from a top edge 142 defined by the top side 116 and a second side edge portion 144 extending from the first side edge portion 140 to the second bottom edge portion 124. As shown, the first side edge portion 140 extends substantially perpendicularly to the top edge 142, while the second side edge portion 144 extends obliquely from the first side edge portion 140 to the second bottom edge portion 124. As shown, the second side edge portion 144 extends inwardly towards the fourth side 120 from the first side edge portion 140.

Moreover, the fourth side 120 includes an inclined edge 150 extending downwardly from the top edge 142 and may be arranged substantially parallel to the second side edge 144 portion of the third side 118. As shown, the inclined edge 150 is arranged at an obtuse angle from the top edge 142 and extends in a direction away from the top edge 142. Further, the fourth side 120 includes a first straight edge portion 152 extending substantially perpendicularly from the third bottom edge portion 126 towards the top edge 142 and a second straight edge portion 154 extending between the inclined edge 150 and the first straight edge portion 152. As shown, the second straight edge portion 154 extends from the inclined edge 150 towards the first straight edge portion 152 and is arranged at offset from the first straight edge portion 152 in a direction of the extension of the top side 116. Accordingly, the second straight edge portion 154 defines a third foot 160 of the gauge body 102. Further, the gauge 100 may include an arcuate scale 162 rigidly attached to the front surface 104 of the gauge body 102 and arranged proximate to the top edge 142.

To facilitate the measurement of one or more first parameters and one or more second parameters, the arcuate plate 108 is configured to rotate relative to the gauge body 102. As shown, the arcuate plate 108 includes a center portion 172 that is arranged proximate to the second bottom edge portion 124 and coupled to the gauge body 102. As shown, the arcuate plate 108 includes a body structure 174 is in the form of an arc of a circle having an arcuate edge 176 disposed distally from the center portion 172, a first radial edge 178 extending from the center portion 172 to the arcuate edge 176, and a second radial edge 182 extending from the center portion 172 towards the arcuate edge 176, and arranged at an angel to the first radial edge 178. The first radial edge 178 is aligned with the first bottom edge portion 122 to initiate the measurement of one or more first parameters of the weld joint and to provide a zero-measurement reference for the measurement of the one or more first parameters.

Additionally, the arcuate plate 108 includes a tip portion 186 extending outwardly from the second radial edge 182 in a direction of extension of the arcuate edge 176. The tip portion 186 is adapted to contact the weld joint to enable the measurement of one or more of the first parameters, for example, the excess weld reinforcement, the depth of welding undercut, the fillet weld leg length, and the outside misalignment. The value for each of the first parameters corresponds to relative angle/position of the first arcuate edge relative to the zero-measurement reference line when the tip portion 186 contacts the weld joint. Further, the second radial edge 182 is adapted to contact the weld joint to facilitate a measurement of the one or more second parameters, for example, the angle of preparation. The value of the angle of preparation is determined based on the relative angle/position of the first arcuate edge relative to the zero-measurement reference line when the second radial edge 182 is arranged contacting the weld joint.

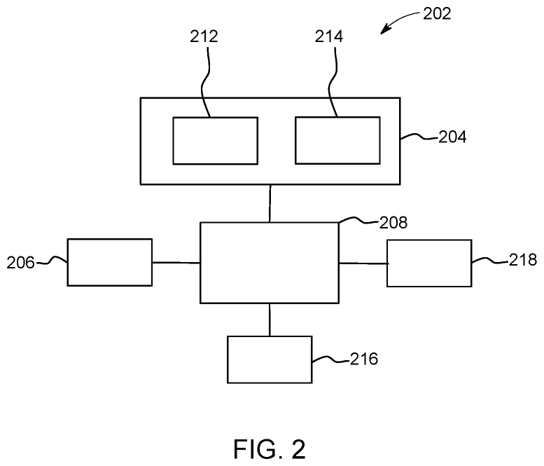

Referring to FIG. 2, to determine the relative positions of the arcuate plate 108 and the gauge body 102, and therefore, measure the one or more first parameters and second parameters, the gauge includes a measuring unit 202 having a sensing unit 204, a display device 206, and a controller 208 arranged in communication with the sensing unit 204 and the display device 206. The sensing unit 204 includes a plurality of first sensors 212 arrayed mounted on one of the arcuate plate 108 and the gauge body 102, for example, on the rear surface 106 of the arcuate plate 108 and at least one second sensor 214 coupled to other of the arcuate plate 108 and the gauge body 102, for example, the front surface 104 of the gauge body 102, and underneath the arcuate plate 108. The plurality of first sensors 212 is arrayed along the arcuate edge 176 of the arcuate plate 108 and extend along the entire arcuate edge 176. The at least one second sensor 214 is arranged proximate to the first side edge portion 140 of the gauge body 102 and underneath the arcuate plate 108. The plurality of first sensors 212 and the at least one second sensor 214 are arranged such that the at least one second sensor 214 is arranged facing one or more first sensors 212.

In the illustrated embodiment, the display device 206 is fixedly mounted to the gauge body 102 at a location proximate to the first side edge portion 140 such that the arcuate edge 176 is arranged underneath the display device 206 and the arcuate plate 108 is configured to slide relative to the display device 206. Further, the at least one second sensor 214 is arranged at a location underneath the display device 206. In some embodiments, the at least one second sensor 214 is mounted to the display device 206. The at least one second sensor 214 is configured to interact with the plurality of first sensors 212 and determines the relative position of the arcuate plate 108 (i.e., the first radial edge 178) relative to the gauge body 102 (i.e., zero-reference measurement line), and shares the measured position with the controller 208. The controller 208, based on input from the sensing unit 204, determines a value of the one or more first parameters being measured.

In an embodiment, the measuring unit may include a mode selector 216 to enable a user to select one or more first parameters, to be measured using the gauge 100. In an embodiment, the mode selector 216 enables the user to select a first mode to measure one or more of first parameters, and a second mode that corresponds to the measurement of one or more of second parameters. In some embodiments, the first mode selector 216 may enable the selection corresponding to each of the first parameters. Accordingly, the controller determines a value corresponding to the input received from the sensing unit 204 and the selected mode using the first mode selector 216, and displays the value via the display device 206.

Additionally, or optionally, the measuring unit 202 may include a measurement unit selector 218 configured to facilitate the user to select a desired measurement unit system out of a plurality of measurement unit system corresponding to the measured parameter. For example, the measurement unit selector 218 enables the user to select between a metric unit system and an imperial unit system. Accordingly, the controller 208 is configured to display the measured value in a desired unit system based on the input from the measurement unit selector 218.

In an embodiment, the mode selector 216 and the measurement unit selector 218 may be a switch or touch button configured to be operated by the user in order to select a desired mode or measurement unit system. Further, the controllers 208 may include a processor to perform various actions associated with the corresponding one of the controllers 208 and a memory for storing instructions related to the measurement of the one or more welding parameters. In an embodiment, the memory may also store values of the one or more welding parameters measured for future reference.

It should be understood that the foregoing description is only illustrative of the aspects of the disclosed embodiments. Various alternatives and modifications can be devised by those skilled in the art without departing from the aspects of the disclosed embodiments.

What is claimed is:

1. A gauge for measuring one or more welding parameters of a weld joint, the gauge comprising:
a gauge body having a first surface;
an arcuate plate rotatably coupled to the gauge body and arranged facing the first surface of the gauge body, wherein the arcuate plate facilitates a measurement of the one or more welding parameters of the weld joint;
a sensing unit configured to determine a relative position of the arcuate plate and the gauge body; and
a controller arranged in communication with the sensing unit and configured to determine a value of the one or more welding parameters based upon an input received from the sensing unit.

2. The gauge of claim 1 further including a display device communicatively coupled with the controller and adapted to display the determined value of the one or more welding parameters.

3. The gauge of claim 1, wherein the sensing unit includes
a plurality of first sensors coupled to one of the gauge body and the arcuate plate, and
at least one second sensor coupled to other of the arcuate plate and the gauge body and configured to interact with the plurality of the first sensors to determine the relative position of the arcuate plate.

4. The gauge of claim 1 further comprising a mode selector to enable a user to select a mode out of a plurality of modes associated with the one or more welding parameters to measure a desired first parameter out of the one or more welding parameters.

5. The gauge of claim 1 further comprising a measurement unit selector to enable a user to select a desired measurement unit system out of a plurality of measurement unit system to display the value of the determined welding parameter in the desired measurement unit system.

6. A gauge for measuring one or more welding parameters of a weld joint, the gauge comprising:
a gauge body having a first surface;
an arcuate plate rotatably coupled to the gauge body and arranged facing the first surface of the gauge body, wherein the arcuate plate facilitates a measurement of one or more welding parameters of the weld joint;
a sensing unit configured to determine a relative position of the arcuate plate and the gauge body;
a controller arranged in communication with the sensing unit and configured to determine a value of the one or more welding parameters based upon an input received from the sensing unit; and
a display device communicatively coupled with the controller and adapted to display the determined value of the one or more welding parameters.

7. The gauge of claim 6, wherein the sensing unit includes
a plurality of first sensors coupled to one of the gauge body and the arcuate plate, and
at least one second sensor coupled to other of the arcuate plate and the gauge body and configured to interact with the plurality of the first sensors to determine the relative position of the arcuate plate.

8. The gauge of claim 6 further comprising a mode selector to enable a user to select a mode out of a plurality of modes associated with the one or more welding parameters to measure a desired first parameter out of the one or more welding parameters.

9. The gauge of claim 6 further comprising a measurement unit selector to enable a user to select a desired measurement unit system out of a plurality of measurement unit system to display the value of the determined welding parameter in the desired measurement unit system.
